(19) United States
(12) Patent Application Publication
(10) Pub. No.: US 2015/0168963 A1
(43) Pub. Date: Jun. 18, 2015

(54) OPTIMIZING FACILITY SPACE ASSIGNMENT

(71) Applicant: International Business Machines Corporation, Armonk, NY (US)

(72) Inventor: Douglas A. Wood, Raleigh, NC (US)

(73) Assignee: International Business Machines Corporation, Armonk, NY (US)

(21) Appl. No.: 14/335,921

(22) Filed: Jul. 20, 2014

Related U.S. Application Data
(63) Continuation of application No. 14/106,321, filed on Dec. 13, 2013.

(51) Int. Cl. G05D 23/19; G06N 5/04; G05B 15/02

(52) U.S. Cl. CPC G05D 23/1932; G05B 15/02; G06N 5/047

(57) ABSTRACT

Provided are techniques for analyzing sensor data received from a plurality of sensors associated with a plurality of buildings to identify a predictive pattern of use corresponding to users of a resource corresponding to the buildings; utilizing the predictive pattern to generate space assignments within the plurality of buildings corresponding to the users with respect to a control loop for allocating the resource based upon a criteria; and optimizing, by the control loop, use of the resource based upon the predicted pattern, the criteria and the space assignments.

### CROSS-REFERENCES TO RELATED APPLICATIONS

The present application is a continuation and claims the benefit of the filing date of an application entitled, “Optimizing Facility Space Assignment” Ser. No. 14/106,321, filed Dec. 13, 2013, assigned to the assignee of the present application, and herein incorporated by reference

### FIELD OF DISCLOSURE

The claimed subject matter relates generally to facility management and, more specifically, to techniques for optimizing the use of space within a facility.

### BACKGROUND OF THE INVENTION

Many current facilities such as office buildings have a large number of installed sensors that measure a wide variety of data, including, but not limited to, occupational and environmental information. Currently, this data is typically employed to adjust lighting and control Heating. Ventilation and Air Conditioning (HVAC) systems. In addition, this data may be stored and analyzed to determine equipment efficiency and maintenance requirements.

### SUMMARY

Provided are techniques for analyzing sensor data received from a plurality of sensors associated with a plurality of buildings to identify a predictive pattern, of use corresponding to users or a resource corresponding to the buildings; utilizing the predictive pattern to generate space assignments within the plurality of buildings corresponding to the users with respect to a control loop for allocating the resource based upon a criteria; and optimizing, by the control loop, use of the resource based upon the predicted pattern, the criteria and the space assignments.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a computing system and facility architecture that may implement the claimed subject matter.

FIG. 2 is a block diagram of a Facility Space Utilization Analysis Device (FSUAD) that may implement aspects of the claimed subject matter.

FIG. 3 is a flowchart or one example of a Generate Optimization process that may implement aspects of the claimed subject matter.

FIG. 4 is a flowchart of one example of a Run Optimization process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory ((SD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented, programming language such as Java, Smalltalk. C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

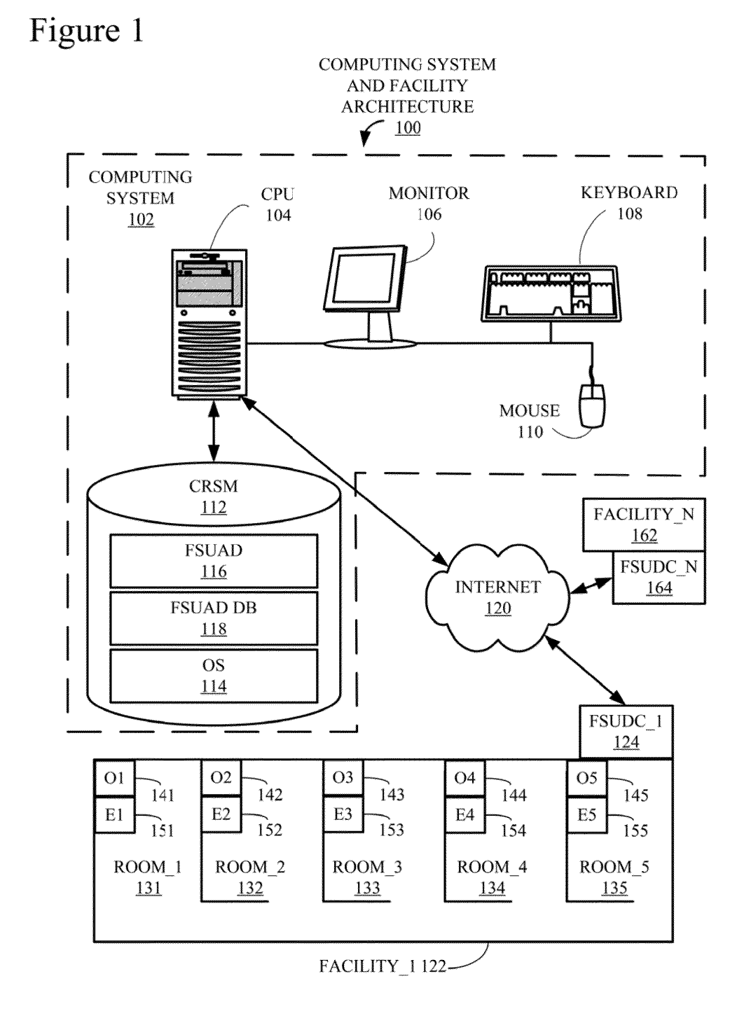

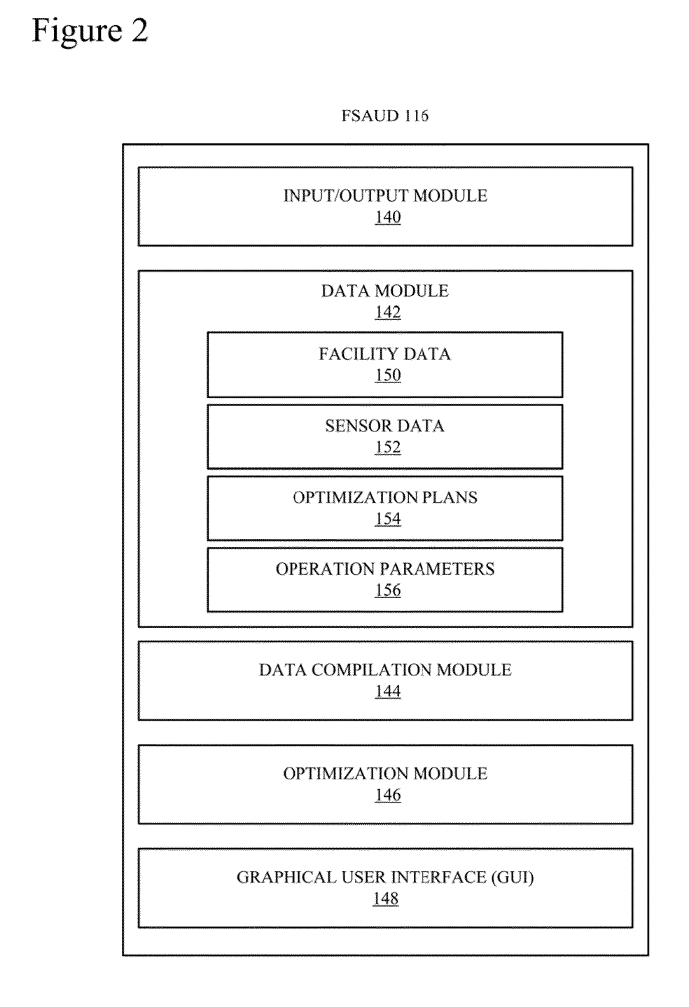

Turning now to the figures, FIG. 1 is a block diagram of one example of a computing system and facility architecture 100 that may implement the claimed subject matter. A computing system 102 includes a central processing unit (CPU) 104, coupled to a monitor 106, a keyboard 108 and a pointing device, or “mouse,” 110, which together facilitate human interaction with elements of architecture 100 and computing system 102. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing an operating system (OS) 114, a Facility Space Utilization Analysis Device (FSUAD) 116 and a FSUAD database (DB) 118. FSAUD 116 and FSAUS DB 118 implement aspects of the claimed subject matter and are explained in more detail below in conjunction with FIGS. 2-4. It should be noted that a typical computing system might include many more components but for the sake of simplicity only a few are shown.

Computing system 102 and CPU 104 are connected to the Internet 120, which is communicatively coupled to a plurality of buildings, or “facilities,” of which two are illustrated, i.e., a facility_{—}1 122 and a facility_N 162. In this example facilities 122 and 162 are office buildings and are connected to computing system 102 via Facility Space Utilization Data Collectors (FSUDCs), i.e. a FSUDC_{—}1 124 and a FSUDC_N 164, which collect and forward to FSUAD 116 readings from various sensors such as sensors 141-145 and 151-155, described below. Although in this example, computing system 102, facility_{—}1 122 and facility_N 162 are communicatively coupled via the Internet 120, they could also be coupled through any number of communication mediums such as, but not limited to, a local area network (LAN) (not shown) and a direct connection. In addition, computing system 102 may be located at either of facilities 122 or 162. Further, it should be noted there are many possible configurations, of which computing architecture 100 is only one simple example.

Facility 122 includes five (5) rooms, i.e., a room_{—}1 131, a room_{—}2 132, a room_{—}3 133, a room_{—}4 134 and a room_{—}5 135. Each room has installed sensors. In this example, room_{—}1131 has an occupational sensor, i.e., an O1 141, and an environmental sensor, i.e., an E1 151. In a similar fashion, room_{—}2 132 includes an O2 142 and an E2 152, room_{—}3 133 includes an O3 143 and an E3 153, room_{—}4 134 includes an O4 144 and an E4 154 and room_{—}5 135 includes an O5 145 and an E5 155. It should be understood that facility 122, rooms 131-135 and sensors 141-145 and 151-155 are merely a very simple example used to describe the claimed subject mailer and the typical facility that would employ the disclosed technology might be much more complex with respect to number of rooms, floors, types of spaces and so on. In addition, although not illustrated for the sake of simplicity, facility_N 162 would also include rooms and sensors.

FIG. 2 is a block diagram of FSAUD 116, introduced above in FIG. 1. in greater detail. FSAUD 116 includes an input/output (I/O) module 140, a data module 142, a Data Compilation module 144, an Optimization module 146 and a graphical user interface (GUI) module 148: For the sake of the following examples, logic associated with FSAUD 116 is assumed to be stored on CRSM 112 (FIG. 1) execute on one or more processors (not shown) of CPU 104 (FIG. 1) of computing system 102 (FIG. 1). It should be understood that the claimed subject matter can be implemented in many types of computing systems and data storage structures but, for the sake of simplicity, is described only in terms of computer 102 and architecture 100 (FIG. 1). Further, the representation of FSAUD 116 in FIG. 2 is a logical model. In other words, components 140, 142, 144, 146 and 148 may be stored in the same or separates files and loaded and/or executed within system 100 either as a single system or as separate processes interacting via any available inter process communication (IPC) techniques.

I/O module 140 handles any communication FSAUD 116 has with other components of architecture 100 and computing system 102. Data module 142 is a data repository for information, including information on facilities being monitored and devices that may be associated with the monitoring, Examples of the types of information stored in data module 142 include facility data 150, sensor data 152, optimization templates, or plans, 154 and operating parameters 156. Facility 150 stores information relating, to the configuration of any facilities, such as facilities 122 and 162 (FIG. 1), that may be a target for the techniques disclosed. Using facility_{—}1 122 as an example, facility data may store information such as, but not limited to, the layout of rooms 131-135 (FIG. 1), the location and type of sensors 141-145 and 151-155 (FIG. 1), address information corresponding to FSUDC 122 (FIG. 1) and the personnel occupancy data.

Sensor data 152 stores information to enable FSAUD 116 to understand data transmitted from different types of sensors. For example, sensors O1-5 141-145 may transmit signals encoded using one particular format and sensors E1_{—}5 151-155 may use a different format. Sensor data 152 also includes information identifying the different types of sensors 141-145 and 151-155. Optimization plans 154 stores different algorithms for converting facility data 150 and sensor data 152 into an actual organizational plan. For example, different plans may focus on the optimization of different parameters. One plan may focus on the optimization of HVAC usage and the personal temperature preferences of individual employees as determined by temperature settings in rooms 131-135. A second plan may focus on maximizing communication by placing employees that interact frequently in close proximity based upon an analysis of movement patterns. In each case, the claimed subject matter is directed to the assignment of users to spaces within facilities 122 and 162 to optimize short term control loops corresponding to facility resources such as HVAC. Other plans may be directed, but are not limited, to:
1) Segregating cleaning or other off hours activity into zone that coincide with HVAC zones;
2) Optimizing space assignment based on incremental cost to occupy a space and/or comfort factor;
3) Organizing teams or individuals with similar space usage time profiles into adjacent spaces, typically the spaces in the same HVAC zone, to allow optimization of services for those spaces;
4) Allowing escalators to be turned, off during low usage periods;
5) Assigning space to reduce elevator usage and/or contention;
6) Determining based on occupancy patterns, the best time to raise and lower HVAC set points;
7) Detecting rogue space usage, that is, consistent usage of unassigned spaces; and
8) Managing building security based on observed space utilization patterns, which may include flagging changes in utilization patterns for investigation.

Operating parameters 156 includes information on various user and administrative preferences that have been set such as, but not limited to, the look and feel of a graphical user interface (GUI) 156, thresholds for action or no action, default values for missing data and preferences related to different potential optimization, plans; and the selection of particular optimization plans 154 to use in different scenarios.

Data Compilation module 144 transforms, interprets and stores information from one or more FSUDCs such as FSUDC_{—}1 124 (FIG. 1) and FSUDC_N 164 (FIG. 1) into FSAUD 116 and data module 142 so that the information is available to optimization module 146. Optimization module 146 processes the data of data module 142 in conformity with a selected plan from optimization plans 154 to produce a specific optimization plan or suggestions. In addition, optimization module 146 is responsible for the discovery of relationships that allow these optimizations is driving by pattern based data mining of facility data 150 and sensor data 152.

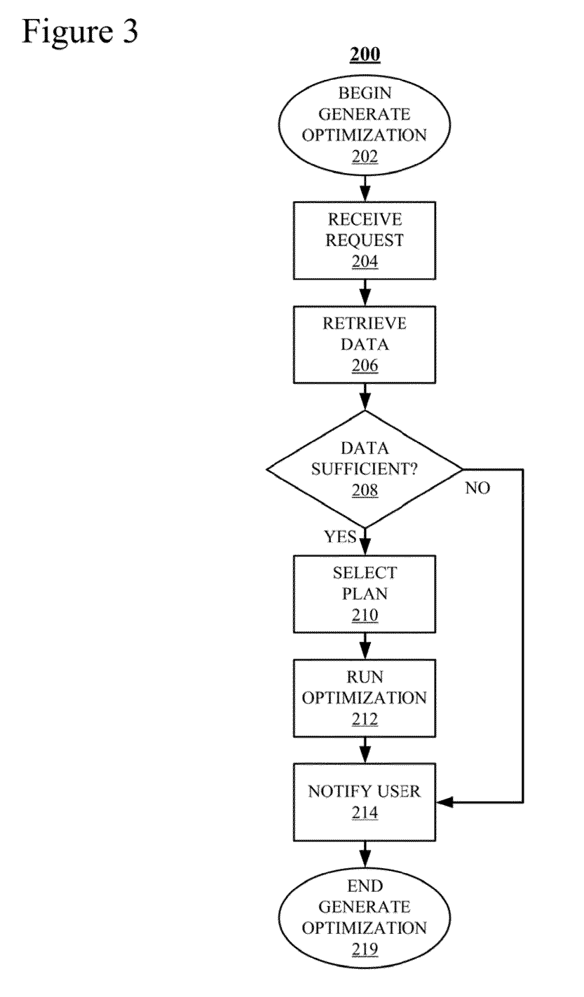

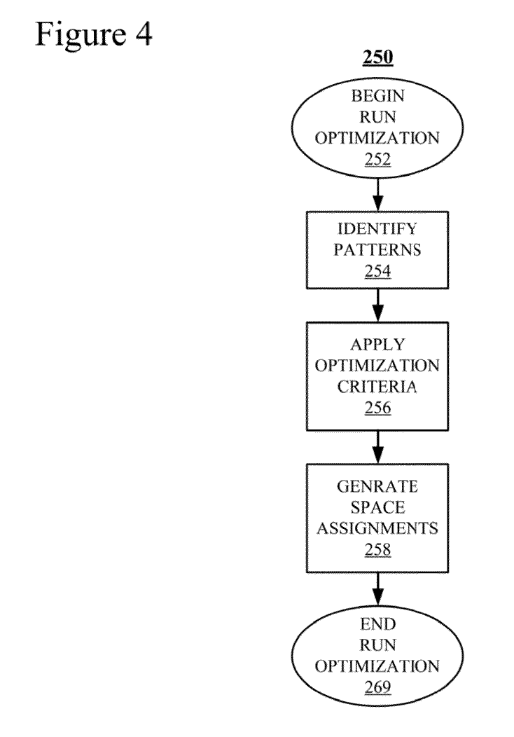

GUI component 148 enables users of FSAUD 116 to interact with and to define the desired functionality of FSAUD 116 and to view, print and distribute optimization plans that have been produces. Components 142, 144, 146, 148, 150, 152, 154 and 156 are described in more detail below in conjunction with FIGS. 3-4.

FIG. 3 is a flowchart of one example of a Generate Optimization process 200 that may implement aspects of the claimed subject matter. In this example, process 200 is associated with logic, stored on CRSM 112 (FIG. 1) in conjunction with FSUAD 116 (FIGS. 1 and 2) and executed on one or more processors (not shown) of CPU 104 (FIG. 1) and computing system 102 (FIG. 1).

Process 200 starts in a “Begin Generate Optimization” block 202 and proceeds immediately to a “Receive Request” block 204. During processing associated with block 204, a request to optimize the assignment of individuals within a number of facilities, which in the following example are facility_{—}1 122 and facility_N 162, is received by FSUAD 116. During processing associated with a “Retrieve Data” block 206, data related to the facilities for which optimization is requested is retrieved from facility data 150 (FIG. 2). As explained above, such data would typically be collected by sensors associated with the facilities and transmitted to FSUAD 116 by FSUDC_{—}1 124 and FSUDC_N 164. Additional information may be provided by users or administrators of FSUAD 116.

During processing associated with a “Data Sufficient?” block 208, a determination is made as to whether or not there is sufficient data available to run the optimization procedures. If so, control proceeds to a “Select Plan” block 210. During processing associated with block 210, the user or administrator, using GUI 148 (FIG. 2), who initiated the request received during processing associated with block 204, selects a specific optimization scheme stored in optimization plans 154 (FIG. 2). The specific plan selected would typically depend upon the particular resource optimization desired.

During processing associated with a “Run Optimization” block 212, a Run Optimization process 250 is executed (see FIG. 4). Once an optimization has been run and a report generated during processing associated with block 212 or, if during processing associated with block 208 a determination is made that there is insufficient data, control proceeds to a “Notify User” block 214. During processing associated with block 214, the user or administrator who initiated the request is notified that a report is available, either providing an optimization plan or notifying that the data was insufficient. Finally, during processing associated with an “End Generate Optimization” block 219, process 200 is complete.

FIG. 4 is a flowchart of one example of a Run Optimization process 250 that may implement aspects of the claimed subject matter. Like process 200, in this example, process 250 is associated with logic stored on CRSM 11.2 (FIG. 1) in conjunction with FSUAD 116 (FIGS. 1 and 2) and executed on one or more processors (not shown) of CPU 104 (FIG. 1) and computing system 102 (FIG. 1).

Process 250 starts in a “Begin Run Optimization” block 252 and proceeds immediately to a “Identify Patterns” block 254. During processing associated with block 254, facility data 150 is “mined” to determine any patterns of usage with respect to the various personnel that are the target of the selected optimization plan (see 210, FIG. 3). During processing associated with an “Apply Optimization Criteria” block 256, the patterns identified during processing associated with block 254 are correlated with the requirements of the selected optimization plan and optimization routines are executed to determine the most efficient placement of personnel with respect to the control loops for managing resources of, in this example, facility_{—}1 122 and facility_N 162 (see 146, FIG. 2).

During processing associated with a “Generate Space Assignments” block 258, a report is generated that reassigns personnel according to the optimizations generated during processing associated with block 256. Finally, control proceeds to an “End Run Optimization” block 269 during which process 250 is complete. In this manner, rather than merely optimizing resources of facilities by controlling the resources, the resources are optimized by moving personnel.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment. Or portion of code, which comprises one Or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
analyzing sensor data received from a plurality of sensors associated with a plurality of buildings to identify a predictive pattern of use corresponding to users of a resource corresponding to the buildings;
utilizing the predictive pattern to generate space assignments within the plurality of buildings corresponding to the users with respect to a control loop for allocating the resource based upon a criteria;
optimizing, by the control loop, use of the resource based upon the predicted pattern, the criteria and the space assignments; and
assigning the users to spaces in the plurality of buildings based upon the space assignments.

2. The method of claim 1, wherein the pattern is a type of pattern selected from a list, the list comprising at least one of:
occupancy;
movement of people; and
space usage.

3. The method of claim 1, wherein each sensor of the plurality of sensors is a sensor type from a list, the list comprising at least one of:
heating, ventilation and air conditioning (HVAC) control;
lighting control; and
water usage.

4. The method of claim 1, wherein the criteria is a criteria type selected from a list, the list comprising at least one of:
cost; and
comfort.

5. The method of claim 1, wherein the optimizing comprises segregating activity associated with the resource.

6. The method of claim 5, wherein the segregating is with respect to a optimization type selected from a list, the list comprising at least one of:
space;
time;
power status of equipment; and
control set points.

7. The method of claim 1, wherein the optimizing comprises segregating activity associated with the resource.
